(19) United States
(12) Patent Application Publication
(10) Pub. No.: US 2025/0209102 A1
(43) Pub. Date: Jun. 26, 2025

(54) INFORMATION PROCESSING DEVICE, INFORMATION PROCESSING METHOD, AND NON-TRANSITORY COMPUTER READABLE STORAGE MEDIUM

(71) Applicant: LY Corporation, Tokyo (JP)

(72) Inventor: Junichi SATO, Tokyo (JP)

(21) Appl. No.: 18/945,372

(22) Filed: Nov. 12, 2024

(30) Foreign Application Priority Data
Dec. 20, 2023 (JP) 2023-215278

(51) Int. Cl. G06F 16/335; G06Q 30/04

(52) U.S. Cl. CPC G06F 16/335; G06Q 30/04

(57) ABSTRACT

An information processing device according to the present application includes a reception unit, a search unit, and a providing unit. The reception unit receives, from another information processing device having received user setting information that is information set by a user, the user setting information via an API defined in advance. The search unit searches for a prompt to be input to generative AI that is used in the other information processing device, based on the user setting information received by the reception unit. The providing unit provides, as a provided prompt, the prompt searched by the search unit to the other information processing device via the API.

### CROSS-REFERENCE TO RELATED APPLICATION

The present application claims priority to and incorporates by reference the entire contents of Japanese Patent Application No. 2023-215278 filed in Japan on Dec. 20, 2023.

### BACKGROUND OF THE INVENTION

### 1. Field of the Invention

The present invention relates to an information processing device, an information processing method, and a non-transitory computer readable storage medium.

### 2. Description of the Related Art

In recent years, there are technologies known to generate information using generative artificial intelligence (AI). For example, Japanese Patent No. 7313757 discloses a technology that uses large language models (LLM), which is a technology that generates a prompt in which effective sentences are added as additional sentences to an input question within a defined character limit. A prompt is information input to the generative AI, which is information indicating an instruction, a request, and the like given to the generative AI for causing the generative AI to execute a specific task, for example.

However, since the large language model to which a question sentence of the user is input generates additional sentences with the conventional technology described above, it may be difficult to provide prompts in a more flexible manner depending on the trained state of the large language model. Therefore, there is room for further improvement in terms of providing appropriate prompts in a more flexible manner.

### SUMMARY OF THE INVENTION

An information processing device according to the present application includes a reception unit, a search unit, and a providing unit. The reception unit receives, from another information processing device having received user setting information that is information set by a user, the user setting information via an API defined in advance. The search unit that searches for a prompt to be input to generative AI that is used in the other information processing device, based on the user setting information received by the reception unit. The providing unit that provides, as a provided prompt, the prompt searched by the search unit to the other information processing device via the API.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for describing information processing according to an embodiment;

FIG. 2 is a diagram illustrating an example of the configuration of an information processing system according to the embodiment;

FIG. 3 is a diagram illustrating an example of the configuration of an information processing device according to the embodiment;

FIG. 4 is a diagram illustrating an example of a prompt table stored in a prompt storage unit of the information processing device according to the embodiment;

FIG. 5 is a flowchart illustrating an example of information processing performed by a processing unit of the information processing device according to the embodiment; and

FIG. 6 is a hardware configuration diagram illustrating an example of a computer that implements functional features of the information processing device according to the embodiment.

### DETAILED DESCRIPTION OF THE PREFERRED EMBODIMENTS

Hereinafter, modes (referred to as “embodiments” hereinafter) for embodying an information processing device, an information processing method, and a non-transitory computer readable storage medium according to the present application will be described in detail with reference to the accompanied drawings. Note that the information processing device, the information processing method, and the non-transitory computer readable storage medium according to present application are not limited by the embodiments. In each of the following embodiments, same reference signs are applied to the same components, and redundant explanations are avoided.

### 1. Example of Information Processing

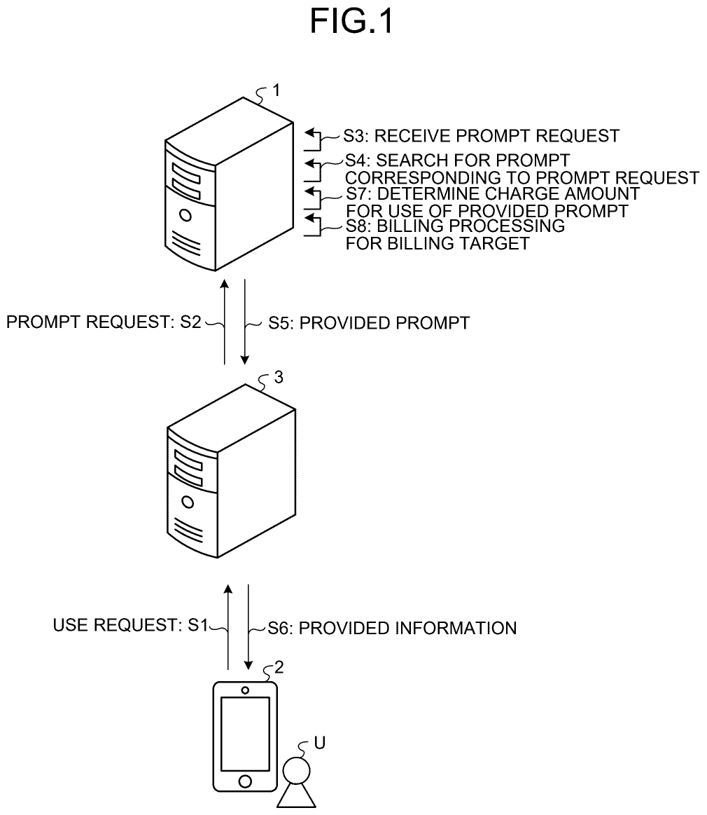

First, an example of information processing according to an embodiment will be described by referring to FIG. 1. FIG. 1 is a diagram for describing information processing according to the present embodiment.

An information processing device 3 illustrated in FIG. 1 is an information processing device that works with each terminal device 2 of a user U and provides various kinds of information online to the user U. For example, it is implemented by one or more servers, a cloud system, or the like. The terminal device 2 is a smartphone, a tablet, a personal computer, or the like, for example.

The information processing device 3 includes generative AI, and provides generative artificial intelligence (AI) providing service that enables the user U to use the generative AI via an application programming interface (API) for such generative AI. The information processing device 3 is an example of another information processing device. In the following, the API for the generative AI may be referred to as a generative AI-API.

The generative AI is, for example, a text-generative AI, an image-generative AI, or a multimodal generative AI. The text-generative AI is, for example, a large language model trained to infer and output the next token from an input sequence of tokens. Examples thereof may be a transformer-based model or a recurrent neural network (RNN)-based model, and a mixture of those models may also be used. The text-generative AI may also be a composite system combined with an identification machine and the like for preventing unauthorized use.

The transformer-based models are, for example, but not limited to, Generative Pre-trained Transformer (GPT), Pathways Language Model Version 2 (PaLM2), and the like. The RNN-based models are, for example, but not limited to, Receptance Weighted Key Value (RWKV), and the like.

The image-generative AI is AI that generates images from texts. Examples thereof are, but not limited to, Generative Adversarial Networks (StackGAN), AttnGAN, Text-to-Image (T2I) with Transformers, Diffusion models, and the like. Examples of the Diffusion models may be DALL-E, Stable-Diffusion, and the like.

The multimodal generative AI is, for example, generative AI that generates at least one of text, image, and audio from at least one of text, image, and audio. The multimodal generative AI is, for example, but not limited to, GPT-4 Turbo with vision, gemini, Chameleon Multimodal Model (CM3Leon), and the like.

An information processing device 1 is an information processing device that provides a prompt providing service that provides, to the information processing device 3, prompts to be input to the generative AI running on the information processing device 3 via the API, and it is implemented by one or more servers, or a cloud system, or the like, for example. In the following, the API provided by the information processing device 1 may be referred to as a prompt-providing API.

As illustrated in FIG. 1, the information processing device 3 receives a use request from the user U (step S1). A use request includes user-related information that contains user setting information. For example, the information processing device 3 receives the user-related information from the user U by receiving a use request transmitted from the terminal device 2 of the user U. The user setting information is information set by the user U.

By operating the terminal device 2, the user U inputs the user setting information into the terminal device 2, and a use request containing the user setting information is transmitted from the terminal device 2 to the information processing device 3. The user setting information included in the use request is, for example, a user prompt that is a prompt input or selected by the user U, request information indicating the request of the user U, or the like.

A user prompt is information indicating a character string the user U is to input to the generative AI, such as, but not limited to, question information indicating a question sentence or instruction information indicating an instruction for causing the generative AI to generate information.

Question information indicating a question sentence is, for example, but not limited to, information of a character string “What restaurant do you recommend for lunch in Roppongi this Saturday?”, information of a character string “What do you think the future of work will be like with the recent advances in AI technology?”, and the like, and instruction information is, for example, but not limited to, information of a character string “Please suggest a three-day travel itinerary in Tokyo.”, information of a character string “Summarize the video at the following address”, and the like.

Request information is, for example, but not limited to, information of a character string indicating a request made by the user U. The request information is, for example, information of a character string “prompt enabling . . . ”, information of a character string “prompt for doing . . . ”, or the like. Note that “ . . . ” is a character string indicating the operation, processing, or the like that the user U desires for the generative AI to do.

For example, the user setting information may be information of a character string “prompt for summarizing the latest information on OOO”, information of a character string “prompt enabling proofreading of sentences”, information of a character string “prompt functioning as a shopping assistant”, and the like. Note that “OOO” is a specific target (for example, a person). The request information is not limited to the examples described above. For example, the request information may be information of a character string that describes the content of the operation, processing, and the like desired by the user U in more details.

Furthermore, it is assumed that additional information needs to be input to the generative AI when the generative AI uses the prompt requested by the user U by the request information or the user prompt. In this case, the user U can input additional information that is information that needs to be input to the generative AI, by operating the terminal device 2. Additional information is information that is input into the generative AI together with the prompt requested by the user U by the request information or the user prompt.

An additional information requiring prompt that is a prompt requiring additional information is, for example, information of a character string that defines the content of a task to be executed by the generative AI based on the input information. The information of character strings defining a task includes information of character strings indicating a definition of the task, a constraint condition of the task, a definition of the behavior and tone of the generative AI, an output format of the generative AI, action examples of the generative AI, and the like, for example. However, the information of the character strings defining the task is not limited thereto, and may include part or all of such information.

The additional information is an additional prompt when the generative AI is a text-generative AI, and it is at least one of an additional prompt and additional image data when the generative AI is a multimodal generative AI.

For example, when a prompt requested by the user U or a user prompt is an additional information requiring prompt, the user U can input the additional information into the terminal device 2 by operating the terminal device 2. Thereby, a use request including the user-related information and the additional information is transmitted from the terminal device 2 to the information processing device 1. The additional information may also be transmitted from the terminal device 2 after the information processing device 3 acquires the provided prompt from the information processing device 1 according to the use request.

An additional information requiring prompt is, for example, information of a character string “You are an experienced travel planner. You propose a three-day travel plan for a specific request from a user. The plan includes places to visit, accommodations, places to eat, and activities.” In this case, the additional information is, for example, information of a character string “Please create a travel plan for Okinawa. My interests are history and cuisine. Budget is 200,000 yen per person.”

Also, an additional information requiring prompt is, for example, information of a character string “You are a good proofreader. You detect up to 20 errors in the input text and suggest corrections. The output format includes incorrect sentences, correct sentences, and descriptions of the errors.” In this case, the additional information is information of the character string to be the target of proofreading.

The user-related information in the use request further contains user information. The user information is information about the user U who is to be the user of the prompt provided by the information processing device 1. The user information includes identification information of the user U. The identification information of the user U is, for example, but not limited to, the identifier (ID) of the user U or a cookie of the browser of the terminal device 2.

Subsequently, upon receiving a use request from the user U, the information processing device 3 transmits a prompt request to the information processing device 1 via the prompt providing API based on the information included in the received use request (step S2).

When additional information is not included in the use request, for example, the information processing device 3 transmits a prompt request containing user setting information to the information processing device 1 via the prompt providing API according to the information included in the use request.

When additional information is included in the use request, the information processing device 3 transmits a prompt request containing user setting information and additional information to the information processing device 1 via the prompt providing API according to the information included in the use request.

Note that the information processing device 3 can determine the attributes of the user U based on the user information included in the use request. In this case, attribute information indicating the attributes of the user U can be included in the prompt request.

At step S2, when a prompt request that is the information from the user U is received and when the user U corresponding to the received user information is the user U determined in advance, for example, the information processing device 3 transmits the prompt request to the information processing device 1 via the prompt providing API.

The user U determined in advance is, for example, the user U who has subscribed to a prompt providing service provided by the administrator or the like of the information processing device 3, the user U set in advance by the administrator of the information processing device 3, or the user U of the terminal device 2 that has transmitted specification information together with the user information. The specification information may be information indicating that the user U desires to try the prompt providing service. However, the specification information is not limited to such an example.

Note that the information processing device 3 can also transmit the prompt request to the information processing device 1 via the prompt providing API, regardless of whether the user U corresponding to the user information is the user U determined in advance.

Then, the information processing device 1 receives the prompt request containing the user setting information transmitted from the information processing device 3 via the prompt providing API (step S3). The information processing device 1 receives the user setting information by receiving the prompt request.

When additional information is included in the prompt request, the information processing device 1 receives the additional information by receiving the prompt request. Furthermore, when attribute information is included in the prompt request, the information processing device 1 receives the attribute information by receiving the prompt request.

Subsequently, the information processing device 1 searches for the prompt to be input to the generative AI used by the information processing device 3 based on the information included in the prompt request received at step S3 (step S4).

The information processing device 1 includes a prompt database containing information of a plurality of prompts, and searches for a prompt to be input to the generative AI used in the information processing device 3 from the prompt database.

Each of the prompts included in the prompt database is, for example, the prompt provided by a prompt provider that is a business operator different from the administrator of the information processing device 3. For example, it is the prompt provided by the administrator or the like of the information processing device 1. Note that the prompts included in the prompt database may also be prompts that are provided by the user U as the prompt provider.

For example, when the generative AI is GPT provided by OpenAI (registered trademark), the prompt contains information of the character strings included in the input information that is input to the generative AI in association with the information indicating the role. The role is the system, user, or the like. The prompt is a prompt that contains at least one out of a system message whose role is system and a user message whose role is a user.

The system message is a prompt indicating the role of the generative AI, for example, and a user message is a prompt indicating a message of the user as the role, for example.

The system message is, for example, information of a character string that defines the content of a task to be executed by the generative AI. The information of the character strings defining the task includes information of character strings indicating a definition of a task, a constraint condition of the task executed in the generative AI, a definition of the behavior and tone of the generative AI, an output format of the generative AI, action examples of the generative AI, and the like, for example. However, the information of the character strings defining the task is not limited thereto, and may include part of such information.

The system message may also be a message indicating a scenario, for example. In that case, for example, the system message may further contain information of a character string indicating a task end condition in the generative AI described above.

A user message is, for example, but not limited to, information of character strings indicating questions, inquiries, instructions, and the like to be processed based on the role of the generative AI indicated in the system message. For example, when a system message is not included in the prompt, the user message may include information of a character string that defines the content of the task to be executed by the generative AI and information of a character string that indicates the question, inquiry, instruction, and the like to be the processing target of the task to be executed by the generative AI.

Furthermore, when the generative AI is GPT provided by OpenAI, the prompt may further include an assistant message whose role is an assistant. The assistant message is an output message by the generative AI or a message that is treated as an output message.

The prompt database contains, for each prompt, information of the prompt including, for example, identification information of the prompt, title of the prompt, heading information of the prompt, vector information of the heading information of the prompt, information indicating the prompt, and the like. Such a prompt database contains a plurality of prompts in a searchable manner.

The heading information of a prompt is information that indicates a description for describing functional features of the prompt (for example, an overview of the functional features, and the like), and vectorization of the heading information of the prompt is performed by embedding using a sentence embedding model (for example, a transformer-based model), for example. The vector information of the heading information of the prompt is represented by, for example, but not limited to, vectors of hundreds of dimensions.

Embedding using a sentence embedding model is, for example, but not limited to, embedding using text-embedding-ada provided by OpenAI, Bidirectional Encoder Representations from Transformers (BERT), and the like.

Note that vectorization of the heading information of the prompt is not limited to embedding using the sentence embedding model. For example, vectorization of the heading information of the prompt may be performed using Doc2Vec, the average of word embedding, and the like. For example, Word2Vec, fastText, and the like are used for word embedding.

The information processing device 1 vectorizes the user setting information included in a prompt request by the same method used when vectorizing the heading information of the prompt. Then, the information processing device 1 acquires the prompts corresponding to the heading information whose similarity of vectors with the user setting information is equal to or higher than a threshold or the top m-pieces (m is 2 or higher) of prompts corresponding to the heading information in descending order of the similarity from the prompt database as prompt candidates.

Instead of the vector information of the heading information of the prompts, the prompt database may contain information of each of a plurality of keywords included in the prompts or the heading information thereof. In this case, for example, the information processing device 1 acquires the prompt that contains one or more terms included in the user setting information in the search request or the prompt corresponding to the heading information from the prompt database as a prompt candidate.

Furthermore, instead of or in addition to the vector information of the heading information of the prompts, the prompt database may also contain the vector information of the prompts. In this case, the information processing device 1 acquires the prompts whose similarity of vectors with the user setting information is equal to or higher than a threshold or the top m-pieces (m is 2 or higher) of prompts in descending order of the similarity from the prompt database as prompt candidates.

The prompt database may also contain information indicating the providing fee of the prompts, information indicating the number of selections of the prompts, information indicating evaluations of the prompts, and the like. The providing fee of the prompt is the fee paid by the administrator of the information processing device 3 or the user U for the use of the prompt.

The information processing device 1 determines whether the type of user setting information is a user prompt or request information. For example, when the prompt request contains type information indicating the type of user setting information, the information processing device 1 determines whether the type of user setting information is a user prompt or request information based on such type information.

The information processing device 1 has, for example, a type determination model that is a language model different from the generative AI of the information processing device 3, which makes it possible to determine whether the type of user setting information is a user prompt or request information using such a type determination model.

The type determination model is, for example, but not limited to, a large language model that is trained to determine whether the type of user setting information is a user prompt or request information by having the user setting information input thereto.

For example, the type determination model may be a general-purpose large language model. In this case, for example, the information processing device 1 inputs information including instruction information and user setting information into the type determination model to cause the type determination model to determine whether the type of user setting information is a user prompt or the request information. The instruction information is, for example, information giving an instruction to determine whether the type of user setting information is a user prompt or request information.

When the type of user setting information is a user prompt, the information processing device 1 uses a prompt comparison/determination model, for example, to determine whether a prompt candidate is capable of acquiring appropriate information more than the user prompt. The information processing device 1 determines, as a search result corresponding to the prompt request, the prompt candidate that is determined by the prompt comparison/determination model to be capable of acquiring appropriate information more than the user prompt.

The prompt comparison/determination model is, for example, but not limited to, a large language model that is trained to determine whether a prompt candidate is more appropriate than a user prompt by having the user prompt and the prompt candidate input thereto.

For example, the prompt comparison/determination model may be a model that is trained to determine whether a prompt candidate is more appropriate than a user prompt by having, in addition to the user prompt and the prompt candidate, information further including the attribute information of the user U input thereto.

The prompt comparison/determination model may also be a general-purpose large language model. In this case, for example, the information processing device 1 inputs instruction information as well as information containing the user prompt and the prompt candidate into the prompt comparison/determination model to cause the prompt comparison/determination model to determine whether the prompt candidate is more appropriate than the user prompt.

In this case, the instruction information is, for example, information giving an instruction to determine whether the prompt candidate is more appropriate than the user prompt. Such instruction information contains, for example, information indicating items to be compared between the prompt candidate and the user prompt and the score for each of the items, and information giving an instruction to determine whether the prompt candidate is more appropriate than the user prompt based on the total values of the scores. Items are, but not limited to, the clarity of the character strings, the degree of relationship between the character strings, the degree of brevity of the character strings, the degree of concreteness of the character strings, the presence of examples, and the like.

The information processing device 1 can also cause the prompt comparison/determination model to determine whether the prompt candidate is more appropriate than the user prompt by inputting information that further includes attribute information of the user U in addition to the instruction information, the user prompt, and the prompt candidate into the prompt comparison/determination model.

In this case, the instruction information is, for example, information that gives an instruction by the user U having the attributes indicated in the attribute information to determine whether the prompt candidate is more appropriate than the user prompt. The instruction information includes, for example, information indicating the items to be compared between the prompt candidate and the user prompt and the score for each of the items, and information giving an instruction to determine whether the prompt candidate is more appropriate than the user prompt based on the total values of the scores.

Furthermore, when the user prompt is an additional information unrequiring prompt, for example, the information processing device 1 transmits each of the user prompt and prompt candidate to the information processing device 3 via the generative AI-API. An additional information unrequiring prompt is a prompt that does not require additional information.

In this case, the information processing device 3 inputs information including the user prompt to the generative AI as input information to cause the generative AI to generate information corresponding to the user prompt, and inputs information including the prompt candidate to the generative AI as input information to cause the generative AI to generate information corresponding to the prompt candidate. The information processing device 3 provides the information corresponding to the user prompt and the information corresponding to the prompt candidate to the information processing device 1.

The information processing device 1 can cause a result comparison/determination model to determine whether the prompt candidate is more appropriate than the user prompt by inputting information that includes the information corresponding to the user prompt and the information corresponding to the prompt candidate provided from the information processing device 3 into the result comparison/determination model. The information processing device 1 determines, as a search result corresponding to the prompt request, the prompt candidate that is determined by the comparison/determination model to be capable of acquiring appropriate information more than the user prompt.

In this case, the result comparison/determination model is, but not limited to, a model that is trained to determine whether a prompt candidate is more appropriate than a user prompt by having information that contains the information corresponding to the user prompt and information corresponding to the prompt candidate input thereto.

The result comparison/determination model may also be a general-purpose large language model. In this case, for example, the information processing device 1 inputs instruction information as well as information containing the information corresponding to the user prompt and the information corresponding to the prompt candidate into the result comparison/determination model to cause the result comparison/determination model to determine whether the prompt candidate is more appropriate than the user prompt.

In this case, the instruction information is, for example, information giving an instruction to determine whether the information corresponding to the prompt candidate is more appropriate than the information corresponding to the user prompt. Such instruction information contains, for example, information indicating items to be compared between the information corresponding to the prompt candidate and the information corresponding to the user prompt and the score for each of the items, and information giving an instruction to determine whether the prompt candidate is more appropriate than the user prompt based on the total values of the scores. Items are, but not limited to, the clarity of the character strings, the degree of relationship between the character strings, the degree of brevity of the character strings, the degree of concreteness of the character strings, the presence of examples, and the like.

The information processing device 1 can also cause the result comparison/determination model to determine whether the prompt candidate is more appropriate than the user prompt by inputting information that further includes attribute information of the user U in addition to the instruction information, the information corresponding to the user prompt, and the information corresponding to the prompt candidate into the result comparison/determination model.

In this case, the instruction information is, for example, information that gives an instruction by the user U having the attributes indicated in the attribute information to determine whether the prompt candidate is more appropriate than the user prompt. The instruction information includes, for example, information indicating the items to be compared between the information corresponding to the prompt candidate and the information corresponding to the user prompt and the score for each of the items, and information giving an instruction to determine whether the prompt candidate is more appropriate than the user prompt based on the total values of the scores.

As described, when the user setting information included in the prompt request received at step S3 is a user prompt, the information processing device 1 can search for a prompt that is assumed to be capable of acquiring appropriate information from the generative AI more than such a user prompt.

The information processing device 1 can also search for a prompt that is assumed to be capable of acquiring appropriate information from the generative AI more than the user prompt, based on the user prompt and the attributes of the user U received at step S3.

Furthermore, when the user setting information received at step S3 is information indicating a request of the user U, the information processing device 1 determines the prompt candidate described above as the prompt corresponding to the information indicating the request.

As described, when the user setting information received at step S3 is a request of the user U, the information processing device 1 can search for a prompt that is the prompt corresponding to the request and provided as a provided prompt.

The information processing device 1 then provides, as the provided prompt, the prompt searched at step S4 to the information processing device 3 via the prompt providing API (step S5). The information processing device 3 acquires the provided prompt transmitted from the information processing device 1 via the prompt providing API, and inputs the information including the provided prompt to the generative AI as input information to cause the generative AI to generate information corresponding to the provided prompt.

Furthermore, when the provided prompt is a prompt that requires additional information, the information processing device 3 inputs the information containing additional information included in the use request and the provided prompt to the generative AI as input information, and causes the generative AI to generate information corresponding to the provided prompt and the additional information.

Then, the information processing device 3 transmits the information generated by the generative AI to the terminal device 2 as provided information to provide, to the user U as provided information, the generation information that is the information generated by the generative AI or information based on the generation information (step S6).

Subsequently, the information processing device 1 determines a usage fee of the provided prompt (step S7). For example, the information processing device 1 determines a higher fee as the providing fee for provided prompts that are assumed to have a higher possibility of acquiring appropriate information from the generative AI.

For example, the information processing device 1 can estimate the degree of possibility of acquiring appropriate information from the generative AI with the provided prompt, based on the evaluations made by the user U on the provided information acquired by using the provided prompt. Information indicating the evaluations of the provided information made by each of the users U is provided to the information processing device 1 from the information processing device 3.

The information processing device 1 estimates that the degree of possibility of acquiring appropriate information from the generative AI is higher with the provided prompt for which the average value of the evaluations of the provided information made by each of the users U is higher, and determines a higher fee as the providing fee.

The information processing device 1 can also estimate the degree of possibility of acquiring appropriate information from the generative AI with the provided prompt, based on the evaluations made by the user U on the provided information acquired by using the provided prompt and the number of times the provided prompt is provided to the information processing device 3. The number of provided times of the provided prompt can also be considered as the number of times the prompt is used by the user U.

For example, the information processing device 1 estimates, as a provided prompt that has a higher degree of possibility of acquiring appropriate information from the generative AI, a provided prompt with a higher score that is acquired by applying weighted addition on the average value of the evaluations of the provided information made by each of the users U and the number of times the provided prompt is provided to the user U.

When the prompt based on the attributes of the user U is the provided prompt, for example, the information processing device 1 can also determine a higher amount for the providing fee, compared to the case where a prompt not based on the attributes of the user U is the provided prompt.

Subsequently, the information processing device 1 performs billing processing for the billing target (step S8). The billing target is, for example, the administrator of the information processing device 3 to which the provided prompt is provided at step S5 or the user U to whom the provided information generated using the provided prompt is provided at step S6. The billing processing is, for example, the processing for charging the billing target for the providing fee of the provided prompt that is provided at step S5.

The information processing device 1 can, for example, perform billing processing by transmitting billing information that includes information indicating the providing fee of the provided prompt and information specifying the billing target to a device of a financial institution, or by transmitting billing information that includes information indicating the providing fee of the provided prompt and information specifying the credit card number of the billing target to a device of a credit card company.

When the billing target is the user U, the information processing device 1 can also charge the providing fee of the provided prompt with points instead of or in addition to a specific currency. For example, the information processing device 1 can also perform the billing processing by transmitting billing information that includes information indicating the number of points corresponding to the providing fee of the provided prompt and information specifying the billing target to a device of a point management company.

Note that points are, for example, but not limited to, rewards given to the user U by a point management company or the like, when the user U as the billing target makes purchases with credit cards or cash, or when the user U as the billing target subscribes to specific services.

As described, the information processing device 1 searches for the prompt input to the generative AI used in the information processing device 3, based on the user setting information received via the prompt providing API (an example of an API defined in advance) from the information processing device 3 (an example of another information processing device) that has received the user setting information that is the information set by the user U. The information processing device 1 provides, as the provided prompt, the searched prompt to the information processing device 3 via the prompt providing API. This allows the information processing device 1 to provide appropriate prompts in a more flexible manner.

Hereinafter, the configuration and the like of an information processing system including the information processing device 1 and the terminal device 2 performing such processing will be described in detail.

### 2. Configuration of Information Processing System

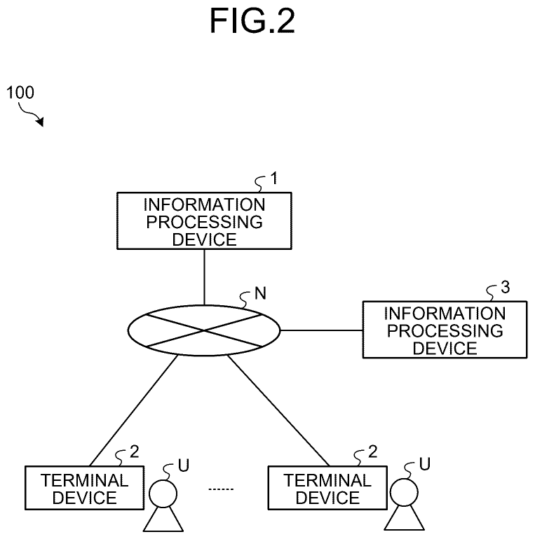

FIG. 2 is a diagram illustrating an example of the configuration of the information processing system according to the present embodiment. As illustrated in FIG. 2, an information processing system 100 according to the present embodiment includes the information processing device 1, a plurality of terminal devices 2, and the information processing device 3.

The terminal devices 2 are used by users U different from each other. The terminal devices 2 are, for example, notebook PCs (personal computers), desktop PCs, smartphones, tablet PCs, and wearable devices. Wearable devices are, for example, but not limited to, smart glasses, smart watches, or the like.

The information processing device 1, the terminal devices 2, and the information processing device 3 are connected to each other in a communicable manner via a network N in a wired or wireless manner. Note that the information processing system 100 illustrated in FIG. 2 may include a plurality of information processing devices 1, 3, and the like.

The network N includes, for example, a wide area network (WAN) such as the Internet and mobile communication networks such as Long Term Evolution (LTE), 4th Generation (4G), and 5th Generation (5G: 5th generation mobile communication system).

The terminal device 2 can communicate with the information processing device 3 and the like by connecting to the network N via short-range wireless communication such as a mobile communication network, Bluetooth (registered trademark), and a wireless local area network (LAN). Furthermore, the information processing device 3 can communicate with the information processing device 1 and the like by connecting to the network N via short-range wireless communication such as mobile communication networks, Bluetooth, and wireless LAN.

### 3. Configuration of Information Processing Device 1

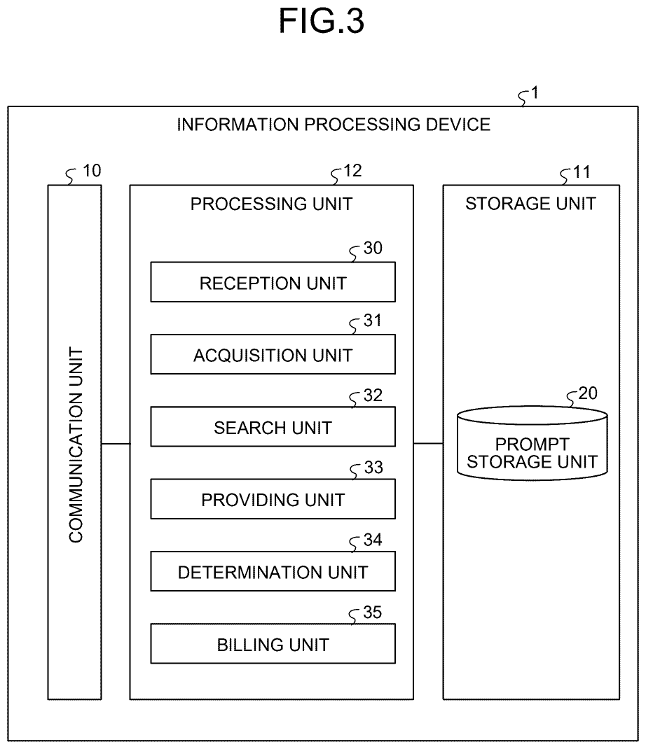

FIG. 3 is a diagram illustrating an example of the configuration of the information processing device 1 according to the present embodiment. As illustrated in FIG. 3, the information processing device 1 includes a communication unit 10, a storage unit 11, and a processing unit 12.

### 3.1. Communication Unit 10

The communication unit 10 is implemented by, for example, a communication module, a network interface card (NIC), and the like. The communication unit 10 is connected to the network N in a wired or wireless manner, and transmits and receives information to and from various other devices. For example, the communication unit 10 transmits and receives information to and from the information processing device 3 via the network N.

### 3.2. Storage Unit 11

The storage unit 11 is implemented, for example, by a semiconductor memory element such as a random access memory (RAM), a flash memory, or a storage device such as a hard disk or an optical disc. The storage unit 11 includes a prompt storage unit 20.

### 3.2.1. Prompt Storage Unit 20

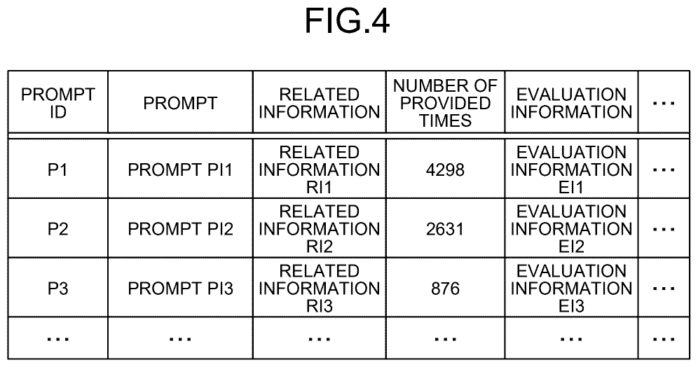

The prompt storage unit 20 stores therein various kinds of information about the prompts. FIG. 4 is a diagram illustrating an example of a prompt table stored in the prompt storage unit 20 of the information processing device 1 according to the present embodiment.

In the example illustrated in FIG. 4, the prompt table stored in the prompt storage unit 20 is an example of the prompt database described above, and includes information on items such as “prompt ID”, “prompt”, “related information”, “number of provided times”, and “evaluation information”. The “prompt ID” is an identifier that identifies the prompt, and it is information assigned to each of the prompts.

The “prompt” is the prompt associated with the “prompt ID”. The prompt is, for example, a prompt provided by a prompt provider that is different from the administrator of the information processing device 3. For example, it is a prompt provided by the administrator or the like of the information processing device 1. Note that the prompts included in the prompt database may also be prompts that are provided by the user U as the prompt provider.

For example, when the generative AI used in the information processing device 3 is GPT provided by OpenAI, the prompt contains information of the character strings included in the input information that is input to the generative AI in association with the information indicating the role. The role is the system, user, or the like. The prompt is a prompt that contains at least one out of a system message whose role is system and a user message whose role is a user.

The system message is a prompt indicating the role of the generative AI, for example, and a user message is a prompt indicating a message of the user as the role, for example.

The system message is, for example, information of a character string that defines the content of a task to be executed by the generative AI used in the information processing device 3. The information of the character strings defining the task includes information of character strings indicating a definition of a task, a constraint condition of the task executed in the generative AI, a definition of the behavior and tone of the generative AI, an output format of the generative AI, action examples of the generative AI, and the like, for example. However, the information of the character strings defining the task is not limited thereto, and may include part of such information.

The system message may also be a message indicating a scenario, for example. In that case, for example, the system message may further contain information of a character string indicating a task end condition in the generative AI described above.

A user message is, for example, but not limited to, information of character strings indicating questions, inquiries, instructions, and the like to be processed based on the role of the generative AI indicated in the system message. For example, when a system message is not included in the prompt, the user message may include information of a character string that defines the content of the task to be executed by the generative AI and information of a character string that indicates the question, inquiry, instruction, and the like to be the processing target of the task to be executed by the generative AI.

The prompt may also be a prompt that includes intention definition information for extracting the intention type and the intention content. Intention definition information includes, for example, instruction information containing an instruction to extract the intention type and the intention content from the user setting information, and definition information containing the information that defines the intention type and the intention content. When the generative AI-API is an API provided by OpenAI (registered trademark), for example, the information processing device 3 can cause the generative AI to generate intention information by using the functional feature of function calling.

The intention type is, for example, the type of intention of the additional information, and the information indicating the intention type is, for example, information specifying the function or the functional feature corresponding to the intention type. Furthermore, the intention content is the content of intention of the additional information, and the information indicating the intention content is, for example, information indicating the function argument or the parameter of the functional feature corresponding to the intention type.

In this case, intention information containing the information indicating the intention type and the information indicating the intention content is generated by the generative AI. The information processing device 3 can cause the generative AI to generate the generation information by acquiring information from an external information processing device, an internal storage unit, or the like using the intention information generated by the generative AI and inputting, to the generative AI, information containing the acquired information and instruction information indicating an instruction to generate the generation information using the acquired information.

Furthermore, when the generative AI used in the information processing device 3 is GPT provided by OpenAI, the prompt may further include an assistant message whose role is an assistant. The assistant message is an output message by the generative AI or a message that is treated as an output message.

The “related information” is information about the prompt associated with the “prompt ID” and includes, for example, identification information of the prompt, title of the prompt, heading information of the prompt, vector information of the heading information of the prompt, vector information of the prompt, information indicating the prompt, information indicating the providing fee of the prompt, and the like. The providing fee of the prompt is the fee paid by the billing target for the use of the prompt.

The heading information of a prompt is information that indicates a description for describing functional features of the prompt (for example, an overview of the functional features, and the like), and vectorization of the heading information of the prompt and vectorization of the prompt are performed by embedding using a sentence embedding model (for example, a transformer-based model), for example. The vector information of the heading information of the prompt is represented by, for example, but not limited to, vectors of hundreds of dimensions.

Embedding using a sentence embedding model is, for example, but not limited to, embedding using text-embedding-ada provided by OpenAI, BERT, and the like. Note that vectorization of the heading information of the prompt and vectorization of the prompt are not limited to embedding using the sentence embedding model. For example, vectorization of the heading information of the prompt and vectorization of the prompt may be performed using Doc2Vec, the average of word embedding, and the like. For example, Word2Vec, fastText, and the like are used for word embedding.

The “number of provided times” is information indicating the number of times the prompt associated with the “prompt ID” is provided to the information processing device 3 as the provided prompt. The “evaluation information” is information indicating the evaluations made by each of the users U on the provided information generated by the processing unit 12 by using the prompt associated with the “prompt ID”. The evaluation of the provided information is on a scale of 10, for example, but may also be on a scale of 9 or lower, or a scale of 11 or higher. The information indicating the evaluation may also be information of character strings such as reviews or comments.

### 3.3. Processing Unit 12

The processing unit 12 is a controller, which is implemented by, for example, a processor such as a central processing unit (CPU) or a micro processing unit (MPU) that executes various computer programs stored in a storage device inside the information processing device 1 (corresponding to an example of an information processing program) using a RAM or the like as a work area.

Furthermore, the processing unit 12 is a controller, which may be implemented by an integrated circuit such as an application specific integrated circuit (ASIC), a field programmable gate array (FPGA), or a general purpose graphic processing unit (GPGPU), for example.

As illustrated in FIG. 3, the processing unit 12 includes a reception unit 30, an acquisition unit 31, a search unit 32, a providing unit 33, a determination unit 34, and a billing unit 35, and implements or executes the functional features and effects of the information processing described below. Note that the internal configuration of the processing unit 12 is not limited to the configuration illustrated in FIG. 3, and may be any other configuration as long as it is configured to perform the information processing described below.

### 3.3.1. Reception Unit 30

The reception unit 30 receives various kinds of information and requests via the network N and the communication unit 10. For example, the reception unit 30 receives a prompt request transmitted from the information processing device 3 via the prompt providing API. The prompt providing API is an example of the API defined in advance.

For example, the reception unit 30 receives user setting information included in the prompt request by receiving the prompt request transmitted from the information processing device 3 via the prompt providing API. The user setting information is the information set by the user U and, for example, it is a user prompt that is a prompt input or selected by the user U, request information indicating the request of the user U, or the like. A user prompt is a prompt that is input or selected by the user U. Request information is information indicating a request made by the user U.

When additional information is included in the prompt request, the reception unit 30 receives the additional information by receiving the prompt request. Furthermore, when attribute information of the user U is included in the prompt request, the reception unit 30 receives the attribute information by receiving the prompt request.

The reception unit 30 receives evaluation information indicating the evaluation made by the user U by receiving the evaluation information that is information indicating the evaluation of the provided information made by the user U and transmitted from the information processing device 3. Note that the reception unit 30 can also acquire the evaluation information from a device (for example, the terminal device 2) other than the information processing device 3.

### 3.3.2. Acquisition Unit 31

The acquisition unit 31 acquires various kinds of information from external devices and the like via the network N and the communication unit 10, and acquires various kinds of information from the storage unit 11.

For example, when a prompt request is received by the reception unit 30, the acquisition unit 31 acquires user setting information included in the prompt request received by the reception unit 30. Furthermore, when the prompt request received by the reception unit 30 contains additional information, the acquisition unit 31 acquires the additional information included in the prompt request.

The acquisition unit 31 also acquires information about the prompts stored in the prompt storage unit 20 of the storage unit 11. The information about the prompt is, for example, identification information of the prompt, title of the prompt, heading information of the prompt, vector information of the heading information of the prompt, vector information of the prompt, information indicating the prompt, information indicating the providing fee of the prompt, and the like.

### 3.3.3. Search Unit 32

The search unit 32 searches for the prompt to be input to the generative AI used by the information processing device 3 as the other information processing device, based on the information included in the prompt request received by the reception unit 30. The prompt request contains, for example, user setting information, additional information, attribute information, and the like, and the search unit 32 searches for the prompt based on such information.

The search unit 32 searches for the prompt to be input to the generative AI used in the information processing device 3 from the prompt table stored in the prompt storage unit 20 included in the storage unit 11. The prompt table is an example of the prompt database described above.

The search unit 32 vectorizes the user setting information included in a prompt request by the same method used when vectorizing the heading information of the prompt (for example, embedding by a sentence embedding model or the like). Then, the search unit 32 acquires, as the prompt candidates, the prompts corresponding to the heading information whose similarity of vectors with the user setting information is equal to or higher than a threshold or the top m-pieces (m is 2 or higher) of prompts corresponding to the heading information in descending order of the similarity from the prompt table in the prompt storage unit 20.

Instead of the vector information of the heading information of the prompts, the prompt table in the prompt storage unit 20 may contain information of each of a plurality of keywords included in the prompts or the heading information thereof. In this case, for example, the search unit 32 acquires a prompt that contains one or more terms included in the user setting information in the search request or a prompt corresponding to the heading information from the prompt table in the prompt storage unit 20 as the prompt candidate.

The search unit 32 determines whether the type of user setting information is a user prompt or request information. For example, when the prompt request contains type information indicating the type of user setting information, the search unit 32 determines whether the type of user setting information is the user prompt or the request information based on such type information.

The search unit 32 has, for example, a type determination model that is a language model different from the generative AI of the information processing device 3, which makes it possible to determine whether the type of user setting information is the user prompt or the request information by using such a type determination model.

The type determination model is, for example, but not limited to, a large language model that is trained to determine whether the type of user setting information is a user prompt or request information by having the user setting information input thereto.

For example, the type determination model may be a general-purpose large language model. In this case, for example, the search unit 32 inputs information including instruction information and user setting information into the type determination model to cause the type determination model to determine whether the type of user setting information is a user prompt or request information. The instruction information is, for example, information giving an instruction to determine whether the type of user setting information is a user prompt or request information. The search unit 32 searches for the prompt that is assumed to be capable of acquiring appropriate information from the generative AI more than the user prompt received by the reception unit 30 and is provided as the provided prompt.

For example, when the type of user setting information is a user prompt, the search unit 32 uses the prompt comparison/determination model, for example, to determine whether a prompt candidate is capable of acquiring appropriate information more than the user prompt. The search unit 32 determines, as a search result corresponding to the prompt request, the prompt candidate that is determined by the prompt comparison/determination model to be capable of acquiring appropriate information more than the user prompt.

The prompt comparison/determination model is, for example, but not limited to, a large language model that is trained to determine whether a prompt candidate is more appropriate than a user prompt by having the user prompt and the prompt candidate input thereto.

For example, the prompt comparison/determination model may be a model that is trained to determine whether a prompt candidate is more appropriate than a user prompt by having, in addition to the user prompt and the prompt candidate, information further including the attribute information of the user U input thereto. This allows the search unit 32 to search for a prompt to be provided as a provided prompt based on the user prompt and the attributes of the user U received by the reception unit 30.

The prompt comparison/determination model may also be a general-purpose large language model. In this case, for example, the search unit 32 inputs instruction information as well as information containing the user prompt and the prompt candidate into the prompt comparison/determination model to cause the prompt comparison/determination model to determine whether the prompt candidate is more appropriate than the user prompt.

In this case, the instruction information is, for example, information giving an instruction to determine whether the prompt candidate is more appropriate than the user prompt. Such instruction information contains, for example, information indicating items to be compared between the prompt candidate and the user prompt and the score for each of the items, and information giving an instruction to determine whether the prompt candidate is more appropriate than the user prompt based on the total values of the scores. Items are, but not limited to, the clarity of the character strings, the degree of relationship between the character strings, the degree of brevity of the character strings, the degree of concreteness of the character strings, the presence of examples, and the like.

The search unit 32 can also cause the prompt comparison/determination model to determine whether the prompt candidate is more appropriate than the user prompt by inputting information that further includes attribute information of the user U in addition to the instruction information, the user prompt, and the prompt candidate into the prompt comparison/determination model.

In this case, the instruction information is, for example, information that gives an instruction by the user U having the attributes indicated in the attribute information to determine whether the prompt candidate is more appropriate than the user prompt. The instruction information includes, for example, information indicating the items to be compared between the prompt candidate and the user prompt and the score for each of the items, and information giving an instruction to determine whether the prompt candidate is more appropriate than the user prompt based on the total values of the scores.

Furthermore, when the user prompt is an additional information unrequiring prompt, for example, the search unit 32 transmits each of the user prompt and prompt candidate to the information processing device 3 via the generative AI-API. An additional information unrequiring prompt is a prompt that does not require additional information.

In this case, the information processing device 3 inputs information including the user prompt to the generative AI as input information to cause the generative AI to generate information corresponding to the user prompt, and inputs information including the prompt candidate to the generative AI as input information to cause the generative AI to generate information corresponding to the prompt candidate. The information processing device 3 provides the information corresponding to the user prompt and the information corresponding to the prompt candidate to the information processing device 1.

The search unit 32 can cause the result comparison/determination model to determine whether the prompt candidate is more appropriate than the user prompt by inputting information that includes the information corresponding to the user prompt and the information corresponding to the prompt candidate provided from the information processing device 3 into the result comparison/determination model. The search unit 32 determines, as a search result corresponding to the prompt request, the prompt candidate that is determined by the comparison/determination model to be capable of acquiring appropriate information more than the user prompt.

In this case, the result comparison/determination model is, but not limited to, a model that is trained to determine whether a prompt candidate is more appropriate than a user prompt by having information that contains the information corresponding to the user prompt and information corresponding to the prompt candidate input thereto.

The result comparison/determination model may also be a general-purpose large language model. In this case, for example, the search unit 32 inputs instruction information as well as information containing the information corresponding to the user prompt and the information corresponding to the prompt candidate into the result comparison/determination model to cause the result comparison/determination model to determine whether the prompt candidate is more appropriate than the user prompt.

In this case, the instruction information is, for example, information giving an instruction to determine whether the information corresponding to the prompt candidate is more appropriate than the information corresponding to the user prompt. Such instruction information contains, for example, information indicating items to be compared between the information corresponding to the prompt candidate and the information corresponding to the user prompt and the score for each of the items, and information giving an instruction to determine whether the prompt candidate is more appropriate than the user prompt based on the total values of the scores. Items are, but not limited to, the clarity of the character strings, the degree of relationship between the character strings, the degree of brevity of the character strings, the degree of concreteness of the character strings, the presence of examples, and the like.

The search unit 32 can also cause the result comparison/determination model to determine whether the prompt candidate is more appropriate than the user prompt by inputting information that further includes attribute information of the user U in addition to the instruction information, the information corresponding to the user prompt, and the information corresponding to the prompt candidate into the result comparison/determination model.

In this case, the instruction information is, for example, information that gives an instruction by the user U having the attributes indicated in the attribute information to determine whether the prompt candidate is more appropriate than the user prompt. The instruction information includes, for example, information indicating the items to be compared between the information corresponding to the prompt candidate and the information corresponding to the user prompt and the score for each of the items, and information giving an instruction to determine whether the prompt candidate is more appropriate than the user prompt based on the total values of the scores. Note that the result comparison/determination model can also have, as input information, information that further includes the user prompt and the prompt candidate.

As described, when the user setting information included in the prompt request received by the reception unit 30 is a user prompt, the search unit 32 can search for a prompt that is assumed to be capable of acquiring appropriate information from the generative AI more than such a user prompt.

The information processing device 1 can also search for a prompt that is assumed to be capable of acquiring appropriate information from the generative AI more than such a user prompt, based on the user prompt and the attributes of the user U received by the reception unit 30.

Furthermore, when the user setting information received by the reception unit 30 is information indicating a request of the user U, the search unit 32 determines the prompt candidate described above as the prompt corresponding to the information indicating the request. As described, when the user setting information received by the reception unit 30 is a request of the user U, the search unit 32 can search for a prompt that is a prompt corresponding to the request and provided as a provided prompt.

### 3.3.4. Providing Unit 33

The providing unit 33 provides, as the provided prompt, the prompt searched by the search unit 32 to the information processing device 3 via the prompt providing API.

The information processing device 3 acquires the provided prompt transmitted from the information processing device 1 via the prompt providing API, and inputs the information including the provided prompt to the generative AI as input information to cause the generative AI to generate information corresponding to the provided prompt.

Furthermore, when the provided prompt is a prompt that requires additional information, the information processing device 3 inputs the information containing additional information included in the use request and the provided prompt to the generative AI as input information, and causes the generative AI to generate information corresponding to the provided prompt and the additional information.

### 3.3.5. Determination Unit 34

The determination unit 34 determines a higher fee as the providing fee for provided prompts that are assumed to have a higher possibility of acquiring appropriate information from the generative AI.

For example, the determination unit 34 can estimate the degree of possibility of acquiring appropriate information from the generative AI with the provided prompt, based on the evaluation made by the user U on the provided information acquired by using the provided prompt.

For example, the determination unit 34 estimates the degree of possibility of acquiring appropriate information from the generative AI with the provided prompt, based on the evaluation information that is the evaluation information stored in the prompt storage unit 20 in the storage unit 11 and acquired by the acquisition unit 31.

The determination unit 34 estimates that the degree of possibility of acquiring appropriate information from the generative AI is higher with the provided prompt for which the average value of the evaluations of the provided information made by each of the users U is higher, and determines a higher fee as the providing fee.

The determination unit 34 can also estimate the degree of possibility of acquiring appropriate information from the generative AI with the provided prompt, based on the evaluation made by the user U on the provided information acquired by using the provided prompt and the number of times the provided prompt is provided to the information processing device 3. The number of provided times of the provided prompt can also be considered as the number of times the prompt is used by the user U.

For example, the determination unit 34 estimates, as a provided prompt that has a higher degree of possibility of acquiring appropriate information from the generative AI, a provided prompt with a higher score that is acquired by applying weighted addition on the average value of the evaluations of the provided information made by each of the users U and the number of times the provided prompt is provided to the user U.

When the prompt based on the attributes of the user U is the provided prompt, for example, the determination unit 34 can also determine a higher amount for the providing fee, compared to the case where a prompt not based on the attributes of the user U is the provided prompt.

The prompt based on the attributes of the user U is a prompt searched by the search unit 32 using the attribute information of the user U, and the prompt not based on the attributes of the user U is a prompt searched by the search unit 32 without using the attribute information of the user U.

### 3.3.6. Billing Unit 35

The billing unit 35 performs billing processing for charging the providing fee of the provided prompt to the billing target, when the provided prompt is provided to the information processing device 3 by the providing unit 33.

The billing target is, for example, the administrator of the information processing device 3 to which the provided prompt is provided by the providing unit 33 or the user U to whom the provided information generated using the provided prompt provided by the providing unit 33 is provided from the information processing device 3. The billing processing is, for example, the processing for charging the billing target for the providing fee of the provided prompt that is provided by the providing unit 33.

The billing unit 35 can, for example, perform billing processing by transmitting billing information that includes information indicating the providing fee of the provided prompt and information specifying the billing target to a device of a financial institution, or by transmitting billing information that includes information indicating the providing fee of the provided prompt and information specifying the credit card number of the billing target to a device of a credit card company.

When the billing target is the user U, the billing unit 35 can also charge the providing fee of the provided prompt with points instead of or in addition to a specific currency. For example, the billing unit 35 can also perform the billing processing by transmitting billing information that includes information indicating the number of points corresponding to the providing fee of the provided prompt and information specifying the billing target to a device of a point management company.

Note that points are, for example, but not limited to, rewards given to the user U by a point management company or the like, when the user U as the billing target makes purchases with credit cards or cash, or when the user U as the billing target subscribes to specific services.

### 4. Processing Procedure

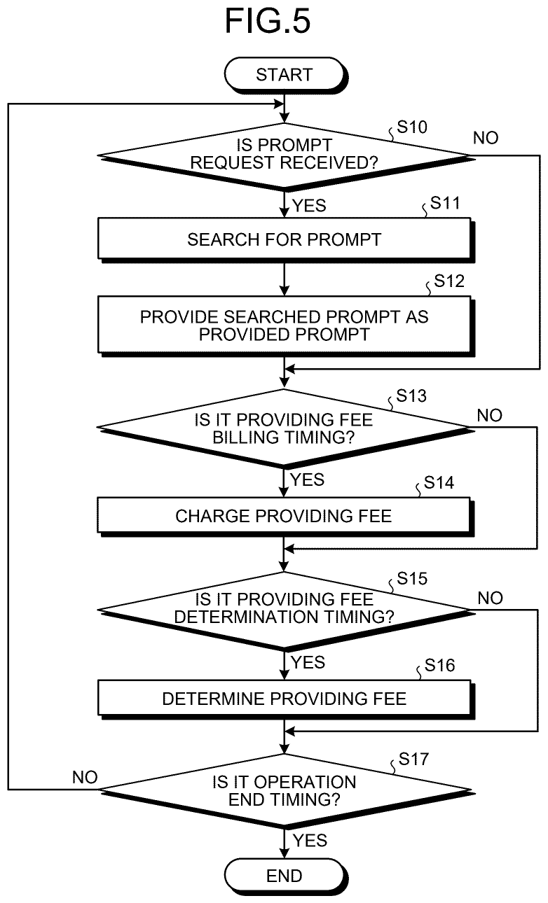

Next, the procedure of information processing performed by the processing unit 12 of the information processing device 1 according to the present embodiment will be described. FIG. 5 is a flowchart illustrating an example of the information processing performed by the processing unit 12 of the information processing device 1 according to the present embodiment.

As illustrated in FIG. 5, the processing unit 12 of the information processing device 1 determines whether a prompt request is received via the prompt providing API (step S10). When determined that a prompt request is received via the prompt providing API (Yes at step S10), the processing unit 12 searches for a prompt corresponding to the prompt request (step S11). The processing unit 12 then provides the searched prompt as the provided prompt (step S12).

When the processing at step S12 is completed, or when determined that no prompt request is received via the prompt providing API (No at step S10), the processing unit 12 determines whether it is a providing fee billing timing (step S13). When determined that it is the providing fee billing timing (Yes at step S13), the processing unit 12 charges the providing fee (step S14).

When the processing at step S14 is completed, or when determined that it is not the providing fee billing timing (No at step S13), the processing unit 12 determines whether it is a providing fee determination timing (step S15). When determined that it is the providing fee determination timing (Yes at step S15), the processing unit 12 determines the providing fee (step S16).

When the processing at step S16 is completed, or when determined that it is not the providing fee determination timing (No at step S15), the processing unit 12 determines whether it is an operation end timing (step S17). For example, in the case where the power of the information processing device 1 is turned off or the like, the processing unit 12 determines that it is the operation end timing.

The processing unit 12 shifts the processing to step S10 when determined that it is not the operation end timing (No at step S17), and ends the processing indicated in FIG. 5 when determined that it is the operation end timing (Yes at step S17).

### 5. Modification Example

In the example described above, upon acquiring a provided prompt transmitted from the information processing device 1, the information processing device 3 inputs information including the provided prompt to the generative AI as input information to cause the generative AI to generate information corresponding to the provided prompt. However, it is not limited to such an example.

For example, the information processing device 3 may transmit the heading information and the like of the provided prompt to the terminal device 2 of the user U upon acquiring the provided prompt transmitted from the information processing device 1, and make an inquiry whether the user U is to use the provided prompt. In this case, the providing unit 33 can transmit a plurality of provided prompts and the heading information of those prompts to the information processing device 3.

Furthermore, in a case where the provided prompt is an additional information requiring prompt and additional information is not included in the use request, when a use request containing additional information is transmitted from the terminal device 2 of the user U after acquiring the provided prompt from the information processing device 1, the information processing device 3 can input the information containing the provided prompt to the generative AI as input information, and cause the generative AI to generate information corresponding to the provided prompt and use information.

Furthermore, when the user setting information received by the reception unit 30 is information indicating a request of the user U, the search unit 32 can determine, among a plurality of prompt candidates, the prompt candidate associated with the attribute information of the user U as the prompt corresponding to the information indicating the request.

### 6. Hardware Configuration

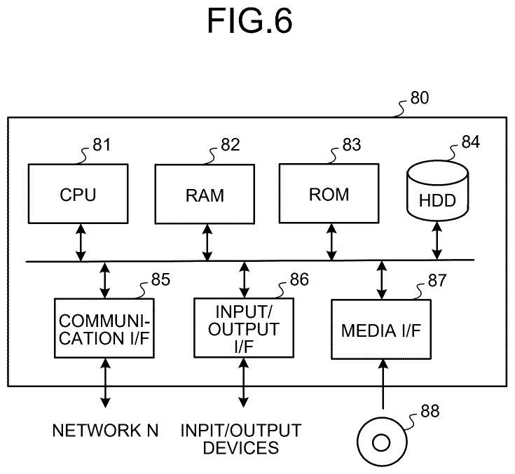

The information processing device 1 according to the present embodiment described above is implemented by a computer 80 with the configuration Illustrated in FIG. 6, for example. FIG. 6 is a hardware configuration diagram illustrating an example of the computer 80 that implements the functional features of the information processing device 1 according to the present embodiment. The computer 80 includes a CPU 81, a RAM 82, a read only memory (ROM) 83, a hard disk drive (HDD) 84, a communication interface (I/F) 85, an input/output interface (I/F) 86, and a media interface (I/F) 87.

The CPU 81 operates based on computer programs stored in the ROM 83 or the HDD 84 to control each of the units. The ROM 83 stores therein a boot program that is executed by the CPU 81 at the startup of the computer 80, as well as computer programs and the like dependent on the hardware of the computer 80.

The HDD 84 stores therein computer programs executed by the CPU 81 as well as data and the like used by such computer programs. The communication interface 85 receives data from other devices via the network N (see FIG. 2) and sends it to the CPU 81, and transmits data generated by the CPU 81 to other devices via the network N.

The CPU 81 controls output devices such as a display, a printer, and the like as well as input devices such as a keyboard, a mouse, or the like via the input/output interface 86. The CPU 81 acquires data from the input devices via the input/output interface 86. The CPU 81 also outputs the generated data to the output devices via the input/output interface 86.

The media interface 87 reads out the computer programs or data stored in a recording medium 88 and provides those to the CPU 81 via the RAM 82. The CPU 81 loads such computer programs onto the RAM 82 from the recording medium 88 via the media interface 87, and executes the loaded computer programs. The recording medium 88 is, for example, an optical recording medium such as a digital versatile disc (DVD) or a phase change rewritable disk (PD), an optical magnetic recording medium such as a magneto-optical disk (MO), a tape medium, a magnetic recording medium, a semiconductor memory, or the like.

For example, when the computer 80 functions as the information processing device 1 according to the present embodiment, the CPU 81 of the computer 80 executes the computer program loaded on the RAM 82 to implement the functional features of the processing unit 12. Furthermore, the data in the storage unit 11 is stored in the HDD 84. The CPU 81 of the computer 80 reads out and executes those programs from the recording medium 88. However, as another example, those programs may be acquired from other devices via the network N.

### 7. Others

Among each kind of the processing described in the above embodiment, all or part of the processing described to be performed automatically may be performed manually, or all or part of the processing described to be performed manually may be performed automatically by known methods. In addition, the information including the processing procedures, specific names, and various kinds of data and parameters indicated in the specification and drawings may be changed as desired, unless otherwise noted. For example, the various kinds of information indicated in each of the drawings are not limited thereto.

Furthermore, each structural component of each device illustrated in the drawings indicates a functional concept, and does not necessarily need to be physically configured as illustrated in the drawings. In other words, the specific form of dispersion and integration of each device is not limited to that illustrated in the drawings, and all or part thereof may be functionally or physically dispersed and integrated in arbitrary units in accordance with various loads, use conditions, and the like.

For example, the information processing device 1 described above may be implemented with a terminal device and a server computer, or with a plurality of server computers. Furthermore, the configuration thereof may be flexibly changed, such as by calling an external platform or the like with API, network computing, or the like depending on the functional features.

Furthermore, the embodiment and the modification example described above can be combined as appropriate to the extent that there is no contradiction in the content of the processing.

### 8. Effects

As described above, the information processing device 1 according to the present embodiment includes the reception unit 30, the search unit 32, and the providing unit 33. The reception unit 30 receives, via the API defined in advance, the user setting information from the information processing device 3 that has received the user setting information that is the information set by the user U. The information processing device 3 is an example of another information processing device. The search unit 32 searches for the prompt to be input to the generative AI used by the information processing device 3, based on the user setting information received by the reception unit 30. The providing unit 33 provides, as the provided prompt, the prompt searched by the search unit 32 to the information processing device 3 via the API. This allows the information processing device 1 to provide appropriate prompts in a more flexible manner.

Furthermore, the user setting information is a user prompt that is a prompt input or selected by the user U, and the search unit 32 searches for the prompt that is assumed to be capable of acquiring appropriate information from the generative AI more than the user prompt received by the reception unit 30 and is provided as the provided prompt. This allows the information processing device 1 to provide appropriate prompts in a more flexible manner.

The search unit 32 also searches for a prompt to be provided as a provided prompt based on the user prompt and the attributes of the user U received by the reception unit 30. This allows the information processing device 1 to provide appropriate prompts in a more flexible manner.

The information processing device 1 also includes the billing unit 35 that charges the administrator of the information processing device 3 for the providing fee of the provided prompt, when the provided prompt is provided by the providing unit 33. This allows the information processing device 1 to easily operate the service that provides appropriate prompts in a more flexible manner.

Furthermore, the information processing device 1 includes the determination unit 34 that determines a higher fee as the providing fee for provided prompts that are assumed to have a higher possibility of acquiring appropriate information from the generative AI. This allows the information processing device 1 to easily operate the service that provides appropriate prompts in a more flexible manner.

When the prompt based on the attributes of the user U is the provided prompt, the determination unit 34 determines a higher amount for the providing fee, compared to the case where a prompt not based on the attributes of the user U is the provided prompt. This allows the information processing device 1 to easily operate the service that provides appropriate prompts in a more flexible manner.

Furthermore, the user setting information is information indicating the request of the user U, and the search unit 32 searches for a prompt that is the prompt corresponding to the information indicating the request received by the reception unit 30 and is provided as the provided prompt. This allows the information processing device 1 to provide appropriate prompts in a more flexible manner.

While the embodiment of the present application is described above in detail based on the accompanying drawings, the embodiment is presented by way of example only, and it is possible to implement the present invention in other forms by applying various changes and modifications based on the knowledge of those skilled in the art on the aspects described in the section of the disclosure of the invention.

Furthermore, “unit” described above can be read as “means” or “circuit”. For example, the acquisition unit can be read as acquisition means or an acquisition circuit.

According to one aspect of the present embodiment, it is possible to provide appropriate prompts in a more flexible manner.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a reception unit that receives, from another information processing device having received user setting information that is information set by a user, the user setting information via an API defined in advance;
a search unit that searches for a prompt to be input to generative AI that is used in the other information processing device, based on the user setting information received by the reception unit; and
a providing unit that provides, as a provided prompt, the prompt searched by the search unit to the other information processing device via the API.

2. The information processing device according to claim 1, wherein
the user setting information is a user prompt that is a prompt input or selected by the user, and
the search unit searches for a prompt that is assumed to be capable of acquiring appropriate information from the generative AI more than the user prompt received by the reception unit, the prompt being provided as the provided prompt.

3. The information processing device according to claim 2, wherein the search unit searches for the prompt to be provided as the provided prompt, based on the user prompt and attributes of the user received by the reception unit.

4. The information processing device according to claim 1, comprising a billing unit that charges an administrator of the other information processing device for a providing fee of the provided prompt, when the provided prompt is provided by the providing unit.

5. The information processing device according to claim 4, comprising a determination unit that determines a higher fee as the providing fee for a provided prompt that is assumed to have a higher possibility of acquiring appropriate information from the generative AI.

6. The information processing device according to claim 5, wherein, when a prompt based on attributes of the user is the provided prompt, the determination unit determines a higher amount for the providing fee compared to a case where a prompt not based on the attributes of the user is the provided prompt.

7. The information processing device according to claim 1, wherein
the user setting information is information indicating a request of the user, and
the search unit searches for a prompt that is a prompt corresponding to the information indicating the request received by the reception unit, the prompt being provided as the provided prompt.

8. An information processing method executed by a computer, the information processing method comprising:
receiving, from another information processing device having received user setting information that is information set by a user, the user setting information via an API defined in advance;
searching for a prompt to be input to generative AI that is used in the other information processing device, based on the user setting information received at the receiving; and
providing, as a provided prompt, the prompt searched at the searching to the other information processing device via the API.

9. A non-transitory computer readable storage medium having stored an information processing program that causes a computer to execute:
receiving, from another information processing device having received user setting information that is information set by a user, the user setting information via an API defined in advance;
searching for a prompt to be input to generative AI that is used in the other information processing device, based on the user setting information received at the receiving; and
providing, as a provided prompt, the prompt searched at the searching to the other information processing device via the API.
